(19) United States
(12) Patent Application Publication
(10) Pub. No.: US 2016/0203389 A1
(43) Pub. Date: Jul. 14, 2016

(54) QUERY METHOD, APPARATUS, SYSTEM AND CLIENT END OF PRODUCT SPECIFICATION

(71) Applicant: INTSIG INFORMATION CO., LTD., Shanghai (CN)

(72) Inventors: Lixin ZHEN, Shanghai (CN); Yue WANG, Shanghai (CN)

(73) Assignee: INTSIG Information Co., Ltd., Shanghai (CN)

(21) Appl. No.: 14/912,543

(22) PCT Filed: Aug. 7, 2014
(86) PCT No.: PCT/CN2014/083863

§ 371 Date: Feb. 17, 2016

(30) Foreign Application Priority Data
Aug. 28, 2013 (CN) 201310380904.7

(51) Int. Cl. G06K 9/62; G06Q 10/10

(52) U.S. Cl. CPC G06K 9/6202; G06Q 10/10

(57) ABSTRACT

The invention discloses a query method, apparatus system and client end of a product specification, a user can acquire a local picture or video by shooting or other ways, the picture or video is subject to feature information extracting, meanwhile, a prestored picture or video corresponding to certain part of the specification is subject to feature information extracting, or prestored feature information is directly called to compare with the feature information acquired by the user, thus querying a specific part in the product specification. Through above technical solutions, the user can query to obtain a corresponding product specification by using a picture or video of certain state or part of a product, thus greatly improving the query efficiency on content of the specification and facilitating the user to acquire information valuable for the user on the product specification.

### BACKGROUND

1. Technical Field

The invention relates to a data query method, in particular to a query method of a product specification. The invention also relates to a data query apparatus, in particular to a query apparatus of the product specification. The invention further relates to a query system of the product specification and a query client end of the product specification.

2. Related Art

When using a new product, a user needs to read a specification inevitably to learn various functions and a use method of the product. However, some products have more functions and parts, a corresponding specification has more contents, it is possible that the user does not need some functions, but the user cannot only pertinently read required parts when reading the specification. At present, along with popularization of a computer technology, many product specifications are made into a format of an electronic edition, which can be downloaded from a network. But compared with paper specifications, the electronic edition specifications only have a form change instead of a substantial change. Problems existing in the paper product specifications still exist in the electronic edition product specifications.

### SUMMARY

A technical problem to be solved by the invention is to provide a query method of a product specification, a query apparatus of the product specification, a query system of the product specification and a client end of the product specification, which can conveniently help a client to only query a required part of the product specification without the trouble of leafing through the specification from begging to end.

In order to solve the technical problem, the invention provides a query method of the product specification, the query method in a technical solution comprises:

establishing a corresponding relation between at least certain part in the product specification and first visual data for displaying certain state or part of a described product, and storing at least certain part in the product specification, the first visual data and the corresponding relation therebetween;

extracting first feature information of the first visual data;

acquiring second visual data for displaying certain state or part of the product, extracting second feature information of the second visual data, or directly acquiring second feature information of the second visual data for displaying certain state or part of the product;

comparing the second feature information with the first feature information to determine whether the first visual data and the second visual data display the same state or part of the product, thereby querying a corresponding part in the product specification, and returning a query result;

the visual data are pictures or videos and the visual data and the feature information have a one-to-one corresponding relation.

The invention further discloses a query apparatus of a product specification capable of being adopted by the query method of the product specification, the query apparatus in a technical solution comprises:

a storing module, storing the product specification, first visual data for displaying certain state or part of a product described by at least certain part in the product specification, and a corresponding relation between the at least certain part in the product specification and the first visual data;

a visual data acquiring module, acquiring second visual data of certain state or part of the product or directly acquiring second feature information of second visual data of certain state or part of the product;

a feature information extracting module, extracting first feature information from the first visual data and second feature information from the second visual data;

a query module, comparing the second feature information with the first feature information to determine whether the first visual data and the second visual data display the same state or part of the product, thereby querying a corresponding part in the product specification, and returning a query result;

the visual data are pictures or videos and the visual data and the feature information have a one-to-one corresponding relation.

The invention further discloses a query system of a product specification capable of being adopted by the query method of the product specification, the query system in a technical solution comprises one network device or a plurality of network devices interconnected by a network, and also comprises:

a storing module, for storing the product specification, first visual data for displaying certain state or part of a product described in at least certain part in the product specification and a corresponding relation between the first visual data and at least certain part in the product specification on at least one network device;

the visual data are pictures or videos, the visual data and the feature information have a one-to-one corresponding relation, and the network device comprises a network server and a client end.

The invention further discloses a query client end of a product specification capable of being adopted by the query method of the product specification, the query system in a technical solution comprises:

a visual data acquiring module, acquiring second visual data of certain state or part of the product or directly acquiring second feature information of second visual data of certain state or part of the product;

through a network, based on the second visual data or second feature information, certain part of the product specification is queried, and certain part of the product specification describes certain state or part of the product displayed by the second visual data;

the visual data are pictures or videos and the visual data and the feature information have a one-to-one corresponding relation.

The invention discloses another query method of a product specification, the query method in a technical solution comprises:

establishing a corresponding relation between at least certain part in the product specification and first feature information of first visual data for displaying certain state or part of a described product, and storing the at least certain part in the product specification, the first feature information and the corresponding relation therebetween;

acquiring second visual data for displaying certain state or part of the product, extracting second feature information of the second visual data, or directly acquiring second feature information of the second visual data for displaying certain state or part of the product;

comparing the second feature information with the first feature information to determine whether the first visual data and the second visual data display the same state or part of the product, thereby querying a corresponding part in the product specification, and returning a query result;

the visual data are pictures or videos and the visual data and the feature information have a one-to-one corresponding relation.

The invention further discloses a query apparatus of a product specification capable of being adopted by another query method of the product specification, the query apparatus in a technical solution comprises:

a storing module, storing the product specification, first feature information of first visual data for displaying certain state or part of a product described by at least certain part in the product specification, and a corresponding relation between the at least certain part in the product specification and the first feature information;

a visual data acquiring module, acquiring second visual data of certain state or part of the product or directly acquiring second feature information of second visual data of certain state or part of the product;

a second feature information extracting module, extracting second feature information from the second visual data;

a query module, comparing the second feature information with the first feature information to determine whether the first visual data and the second visual data display the same state or part of the product, thereby querying a corresponding part in the product specification, and returning a query result;

the visual data are pictures or videos and the visual data and the feature information have a one-to-one corresponding relation.

The invention further discloses a query system of a product specification capable of being adopted by another query method of the product specification, the query system in a technical solution comprises one network device or a plurality of network devices interconnected by a network, and also comprises:

a storing module, storing the product specification, first feature information of first visual data for displaying certain state or part of a product described in at least certain part in the product specification and a corresponding relation between the first feature information and at least certain part in the product specification on at least one network device;

the visual data are pictures or videos, the visual data and the feature information have a one-to-one corresponding relation, and the network device comprises a network server and a client end.

The invention further discloses a query client end of a product specification capable of being adopted by another query method of the product specification, the query system in a technical solution comprises:

a visual data acquiring module, acquiring second visual data of certain state or part of the product or directly acquiring second feature information of second visual data of certain state or part of the product;

through a network, based on the second visual data or second feature information, certain part of the product specification is queried, and certain part of the product specification describes certain state or part of the product displayed by the second visual data;

the visual data are pictures or videos and the visual data and the feature information have a one-to-one corresponding relation.

According to the technical solutions of the invention, a user can query a corresponding product specification by using a picture or video of certain state or part of a product, thus greatly improving the query efficiency on content of the specification and facilitating the user to acquire information valuable for the user on the product specification.

### BRIEF SPECIFICATION OF THE DRAWINGS

The invention is illustrated in great detail in combination with drawings and embodiments.

FIG. 1 is a module schematic diagram of one embodiment of a query apparatus of a product specification of the invention.

FIG. 2 is a module schematic diagram of one embodiment of a query system of a product specification of the invention.

FIG. 3 is a module schematic diagram of one embodiment of a query client end of a product specification of the invention.

FIG. 4 is a module schematic diagram of another embodiment of a query apparatus of a product specification of the invention.

FIG. 5 is a module schematic diagram of another embodiment of a query system of a product specification of the invention.

FIG. 6 is a module schematic diagram of another embodiment of a query client end of a product specification of the invention.

### DETAILED SPECIFICATION

The invention discloses a query method of a product specification, comprising:

establishing a corresponding relation between at least certain part in the product specification and first visual data for displaying certain state or part of a described product, and storing the at least certain part in the product specification, the first visual data and the corresponding relation therebetween;

extracting first feature information of the first visual data;

acquiring second visual data for displaying certain state or part of the product, extracting second feature information of the second visual data, or directly acquiring second feature information of the second visual data for displaying certain state or part of the product;

comparing the second feature information with the first feature information to determine whether the first visual data and the second visual data display the same state or part of the product, thereby querying a corresponding part in the product specification, and returning a query result;

the visual data are pictures or videos and the visual data and the feature information have a one-to-one corresponding relation.

The feature information is a data section uniquely corresponding to certain visual data, there are many kinds of corresponding relations, for example, a corresponding relation is obtained by operation of the visual data through a specific algorithm or is artificially established between the feature information and the visual data. At present, such technology is very mature and a specific implementation process thereof is not repeated herein.

In the query method of the product specification, the product specification is at least one of a text, picture, audio format or video format. Besides the product specification in traditional text and picture formats, the invention can be described by adopting the product specification in an audio or video format, for example, a length of audio is made for describing functions or a use method of a product, or a length of video is made for guiding a user to use the product.

In the query method of the product specification, there are two ways for directly acquiring the second visual data and second feature information:

1, shooting certain state or part of the product or the second feature information;

2, acquiring a file containing the second visual data or second feature information.

In terms of directly acquiring the second feature information through shooting, the second feature information is made into a label, for example, a character string format, or a format of a bar code and a two-dimension code, which is adhered to a specific part of the product, and content of the second feature information is read through an image recognition technology after shooting.

In the query method of the product specification, a way of directly acquiring the second visual data and the second feature information also comprises, selecting a local containing the second visual data from the visual data of large size as the second visual data; or selecting a local containing the second feature information from the visual data of large size as the second feature information. For example, on a picture of a whole product, a part displaying certain local of the product is selected, and such part of the picture is used for describing the part of the local product specification of the product. Or in a length of video of the product, a part or passage of certain local of the product displayed in the video is selected, and a part of the local product specification of the displayed product is queried or described accordingly.

In order to facilitate a case without a network, the query method of the product specification can be realized in a computer system. The product specification, first visual data and a corresponding relation thereof are stored in the same computer system, first feature information is extracted in the computer system, the second visual data and second feature information are acquired in the computer system, or the second feature information is directly acquired, and the second feature and the first feature information are compared in the computer system to query a corresponding part in the product specification and return a query result.

The query method of the product specification is realized based on the network, at all same, or partial same or all different network positions, the product specification, the first visual data and a corresponding relation between the at least certain part in the product specification and the first visual data are stored, the first feature information is extracted, the second visual data are acquired or the second feature information is directly acquired, the second feature information is extracted from the second visual data, and the second feature information and the first feature information are compared; different network positions perform communication connection by a network, and are used for transmitting the visual data, the feature information or a query result.

In the query method of the product specification, the query result may comprise certain part in the product specification, and also comprises a positioning indication of certain part in the product specification. A query result can be certain part in the product specification directly provided to a user, the user may be told with a position where certain required part in the product specification is, for example, the user is provided with a network link to look up, or the user is told with which chapter or which page the required part is at.

In an implementation process of the query method of the product specification, a product specification is assigned, and then in the assigned product specification, a corresponding part therein is queried. Different products may have parts with same or similar appearances, but these parts possibly have different functions or use methods. In order to more accurately provide the product specification, one specific product specification may be pre-assigned, and then the content required by the user is queried in the product specification. A product specification assigning way can be determined by the user or automatically determined by a hardware system.

The query method of the product specification also comprises, newly establishing first visual data of certain state or part of the product described by at least certain part in the product specification, establishing a corresponding relation between the at least certain part in the product specification and the first visual data, and storing the at least certain part in the product specification, the first visual data and a corresponding relation therebetween. Hence, the user can add the first visual data corresponding to a specific part of the specification according to needs of the user and future looking up is facilitated.

The query method of the product specification also comprises, newly establishing at least certain part in the product specification, establishing a corresponding relation between the at least certain part in the product specification and the first visual data for displaying certain state or part of the described product, and storing the at least certain part in the product specification, the first visual data and a corresponding relation therebetween. Hence, the user can add relevant specification corresponding to the specific first visual data by self aiming at a part not specified or clearly specified in the specification according to own use experiences, and future looking up is facilitated.

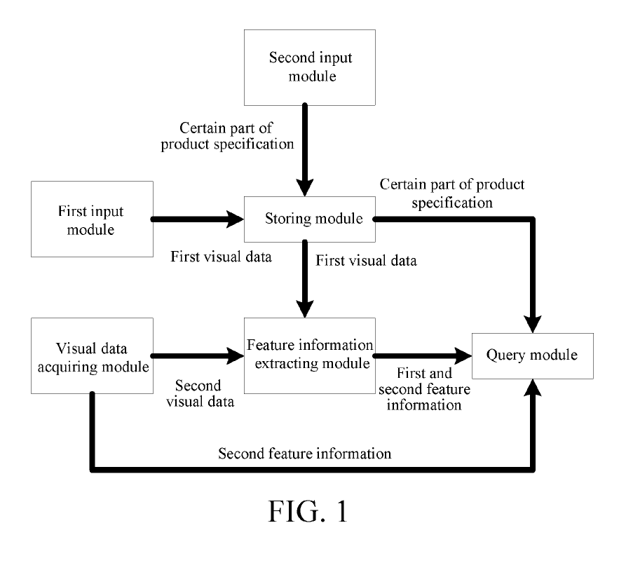

The invention also discloses a query apparatus for a product specification for realizing above query method of the product specification, as shown in FIG. 1, comprising:

a storing module, storing the product specification, first visual data for displaying certain state or part of a product described by at least certain part in the product specification, and a corresponding relation between the at least certain part in the product specification and the first visual data;

a visual data acquiring module, acquiring second visual data of certain state or part of the product or directly acquiring second feature information of second visual data of certain state or part of the product;

a feature information extracting module, extracting first feature information from the first visual data and second feature information from the second visual data;

a query module, comparing the second feature information with the first feature information to determine whether the first visual data and the second visual data display the same state or part of the product, thereby querying a corresponding part in the product specification, and returning a query result;

in the query apparatus of the product specification, the visual data are pictures or videos and the visual data and the feature information have a one-to-one corresponding relation.

In the query apparatus of the product specification, the product specification is at least one of a text, picture, audio format or video format.

In the query apparatus of the product specification, the visual data acquiring module comprises a shooting apparatus, for shooting certain state or certain part of a product or second feature information, to acquire the second visual data or directly acquire the second feature information.

The query apparatus of the product specification also comprises a visual data processing module, selecting a local containing the second visual data from the visual data of large size as the second visual data; or selecting a local containing the second feature information from the visual data of large size as the second feature information.

In the query apparatus of the product specification, the query result comprises certain part in the product specification or at least one of position indications of certain part in the product specification.

The query apparatus of the product specification also comprises a first input module, inputting and displaying first visual data of certain state or part of a product described by at least certain part in the product specification, establishing a corresponding relation between the at least certain part in the product specification and the first visual data, and storing the at least certain part in the product specification, the first visual data and a corresponding relation therebetween in the storing module.

The query apparatus of the product specification also comprises a second input module, inputting at least certain part in the product specification, establishing a corresponding relation between the at least certain part in the product specification and the first visual data for displaying certain state or part of a described product, and storing the at least certain part in the product specification, the first visual data and a corresponding relation therebetween in the storing module.

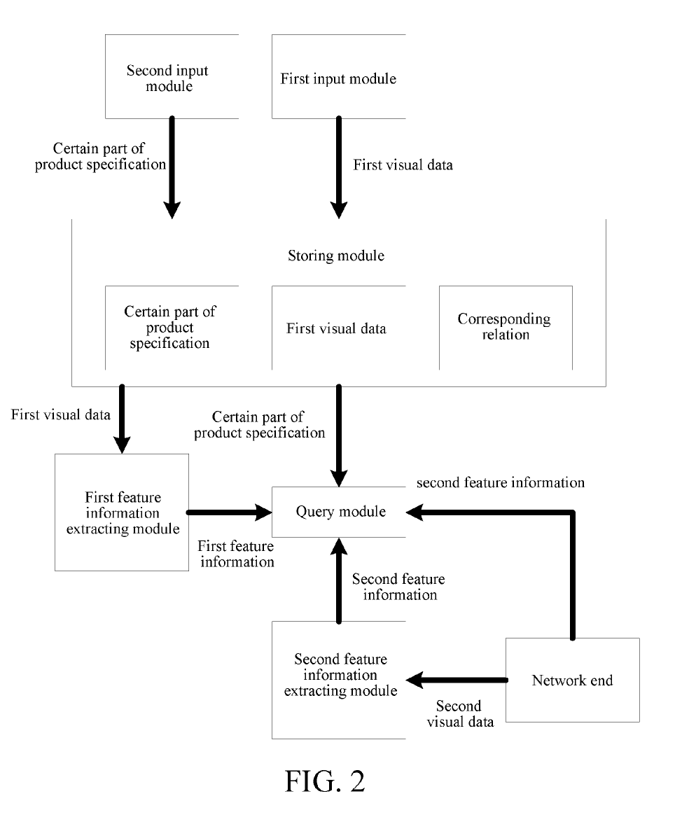

The invention further discloses a query system for a product specification for realizing above query method of the product specification, as shown in FIG. 2, the query system comprises one network device or a plurality of network devices interconnected by a network, and also comprises:

a storing module, for storing the product specification, first visual data for displaying certain state or part of a product described in at least certain part in the product specification and a corresponding relation between the first visual data and at least certain part in the product specification on at least one network device;

the visual data are pictures or videos, the visual data and the feature information have a one-to-one corresponding relation, and the network device comprises a network server and a client end.

In the query system of the product specification, the network device also comprises a first feature information extracting module for extracting first feature information from the first visual data. The first feature information extracting module is arranged on any network device.

The query system of the product specification also comprises a query module for comparing the second feature information with the first feature information to determine whether the first visual data and the second visual data display the same state or part of the product, thereby querying a corresponding part in the product specification, and returning a query result; the second feature information is sent from a network, or the second visual data are sent from the network, and the second feature information is extracted from the second visual data by a second feature information extracting module. The query module and the second feature information extracting module can be arranged on any network device.

In the query system of the product specification, the product specification is at least one of a text, picture, audio format or video format.

In the query system of the product specification, the query result comprises certain part in the product specification or at least one of position indications of certain part in the product specification.

The query system of the product specification also comprises a first input module, inputting and displaying first visual data of certain state or part of a product described by at least certain part in the product specification, establishing a corresponding relation between the at least certain part in the product specification and the first visual data, and storing the at least certain part in the product specification, the first visual data and a corresponding relation therebetween in the storing module.

The query system of the product specification also comprises a second input module, inputting at least certain part in the product specification, establishing a corresponding relation between the at least certain part in the product specification and the first visual data for displaying certain state or part of a described product, and storing the at least certain part in the product specification, the first visual data and a corresponding relation therebetween in the storing module.

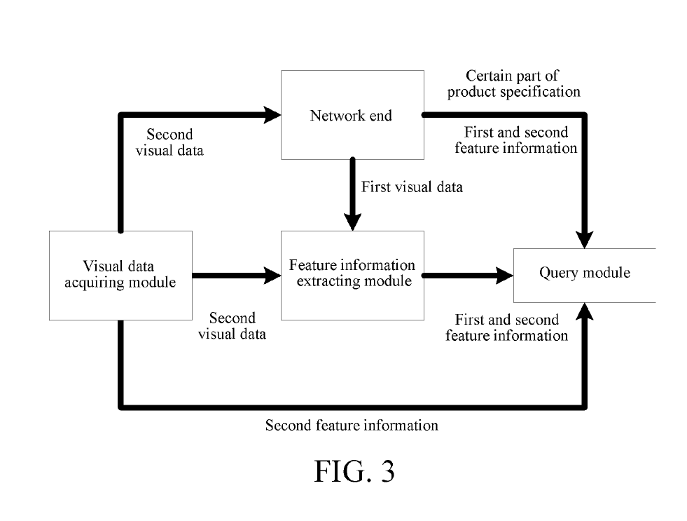

The invention further discloses a query client end for a product specification for realizing above query method of the product specification, as shown in FIG. 3, comprising:

a visual data acquiring module, acquiring second visual data of certain state or part of the product or directly acquiring second feature information of second visual data of certain state or part of the product;

through a network, based on the second visual data or second feature information, certain part of the product specification is queried, and certain part of the product specification describes certain state or part of the product displayed by the second visual data;

the visual data are pictures or videos and the visual data and the feature information have a one-to-one corresponding relation.

In the query client end of the product specification, if the visual data acquiring module acquires the second visual data, the second feature information can be locally extracted at a query client end of the product specification, therefore, the query client end also comprises a second feature information extracting module, extracting the second feature information from the second visual data. In addition, the second visual data can be uploaded by a network, and the second feature information is extracted by other devices on the network.

The query client end of the product specification also comprises a first feature information extracting module, the first visual data are downloaded from the network, and the first feature information is extracted from the first visual data by the first feature information extracting module.

In the query client end of the product specification, since the first feature information and the second feature information may be same in an extracting way, the first feature information extracting module and the second feature information extracting module are the same module to save system resource.

The query client end of the product specification also comprises a query module for comparing the second feature information with the first feature information to determine whether the first visual data and the second visual data display the same state or part of the product, thereby querying a corresponding part in the product specification, and returning a query result.

In the query client end of the product specification, the query result comprises certain part in the product specification or at least one of position indications of certain part in the product specification.

In the query client end of the product specification, the product specification is at least one of a text, picture, audio format or video format.

In the query client end of the product specification, the visual data acquiring module comprises a shooting apparatus, for shooting certain state or certain part of a product or second feature information, to acquire the second visual data or directly acquire the second feature information.

The query client end of the product specification also comprises a visual data processing module, selecting a local containing the second visual data from the visual data of large size as the second visual data; or selecting a local containing the second feature information from the visual data of large size as the second feature information.

The query client end of the product specification also comprises a first input module, inputting and displaying first visual data of certain state or part of a product described by at least certain part in the product specification, establishing a corresponding relation between the at least certain part in the product specification and the first visual data, and locally storing or uploading the at least certain part in the product specification, the first visual data and a corresponding relation therebetween through a network.

The query client end of the product specification also comprises a second input module, inputting at least certain part in the product specification, establishing a corresponding relation between the at least certain part in the product specification and the first visual data for displaying certain state or part of a described product, and locally storing or uploading the at least certain part in the product specification, the first visual data and a corresponding relation therebetween through a network.

The invention also discloses another query method of the product specification, the biggest difference between which and above query method of the product specification lies in that in above query method of the product specification, the first visual data correspond to at least certain part in the product specification, while in another query method of the product specification, the first feature information corresponds to the at least certain part in the product specification. Compared with above query method of the product specification, the query method of the product specification omits the step of extracting the first feature information from the first visual data.

A technical content of the query method of the product specification specifically comprises: establishing a corresponding relation between at least certain part in the product specification and first feature information of first visual data for displaying certain state or part of a described product, and storing the at least certain part in the product specification, the first feature information and the corresponding relation therebetween;

acquiring second visual data for displaying certain state or part of the product, extracting second feature information of the second visual data, or directly acquiring second feature information of the second visual data for displaying certain state or part of the product;

comparing the second feature information with the first feature information to determine whether the first visual data and the second visual data display the same state or part of the product, thereby querying a corresponding part in the product specification, and returning a query result;

the visual data are pictures or videos and the visual data and the feature information have a one-to-one corresponding relation.

In the query method of the product specification, the product specification is at least one of a text, picture, audio format or video format.

In the query method of the product specification, ways for directly acquiring the second visual data and second feature information comprise:

shooting certain state or part of the product or the second feature information;

acquiring a file containing the second visual data or second feature information.

In the query method of the product specification, a way of directly acquiring the second visual data and the second feature information also comprises, selecting a local containing the second visual data from the visual data of large size as the second visual data; or selecting a local containing the second feature information from the visual data of large size as the second feature information.

In the query method of the product specification, the product specification, the first feature information and a corresponding relation thereof are stored in the same computer system, the second visual data and second feature information are acquired in the computer system, or the second feature information is directly acquired, and the second feature and the first feature information are compared in the computer system to query a corresponding part in the product specification and return a query result.

The query method of the product specification is realized based on the network, at all same, or partial same or all different network positions, the product specification, the first feature information and a corresponding relation between the at least certain part in the product specification and the first feature information are stored, the second visual data are acquired or the second feature information is directly acquired, the second feature information is extracted from the second visual data, and the second feature information and the first feature information are compared; different network positions perform communication connection by a network, and are used for transmitting the visual data, the feature information or a query result.

In the query method of the product specification, the query result comprises certain part in the product specification, or at least one of indication positions of certain part in the product specification.

In the query method of the product specification, a specific product specification is assigned, and then in the assigned product specification, a corresponding part therein is queried.

The query method of the product specification also comprises, newly establishing first feature information of the first visual data of certain state or part of the product described by at least certain part in the product specification, establishing a corresponding relation between the at least certain part in the product specification and the first feature information, and storing the at least certain part in the product specification, the first feature information and a corresponding relation therebetween.

The query method of the product specification also comprises, newly establishing at least certain part in the product specification, establishing a corresponding relation between the at least certain part in the product specification and the first feature information of the first visual data for displaying certain state or part of the described product, and storing the at least certain part in the product specification, the first feature information and a corresponding relation therebetween.

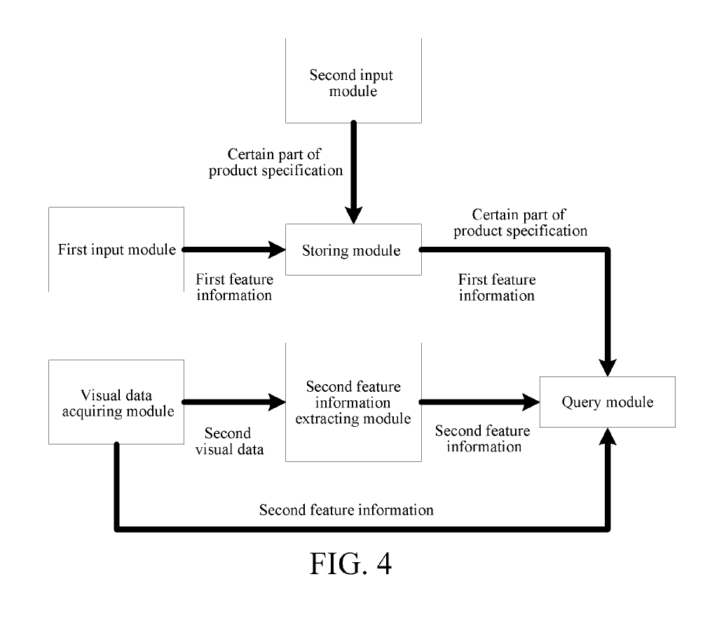

The invention also discloses a query apparatus for a product specification for realizing above query method of the product specification, as shown in FIG. 4, comprising:

a storing module, storing the product specification, first feature information of first visual data for displaying certain state or part of a product described by at least certain part in the product specification, and a corresponding relation between the at least certain part in the product specification and the first feature information;

a visual data acquiring module, acquiring second visual data of certain state or part of the product or directly acquiring second feature information of second visual data of certain state or part of the product;

a second feature information extracting module, extracting second feature information from the second visual data;

a query module, comparing the second feature information with the first feature information to determine whether the first visual data and the second visual data display the same state or part of the product, thereby querying a corresponding part in the product specification, and returning a query result;

the visual data are pictures or videos and the visual data and the feature information have a one-to-one corresponding relation.

In the query apparatus of the product specification, the product specification is at least one of a text, picture, audio format or video format.

In the query apparatus of the product specification, the visual data acquiring module comprises a shooting apparatus, for shooting certain state or certain part of a product or second feature information, to acquire the second visual data or directly acquire the second feature information.

The query apparatus of the product specification also comprises a visual data processing module, selecting a local containing the second visual data from the visual data of large size as the second visual data; or selecting a local containing the second feature information from the visual data of large size as the second feature information.

In the query apparatus of the product specification, the query result comprises certain part in the product specification or at least one of position indications of certain part in the product specification.

The query apparatus of the product specification also comprises a first input module, inputting and displaying first feature information of the first visual data of certain state or part of a product described by at least certain part in the product specification, establishing a corresponding relation between the at least certain part in the product specification and the first feature information, and storing the at least certain part in the product specification, the first feature information and a corresponding relation therebetween in the storing module.

The query apparatus of the product specification also comprises a second input module, inputting at least certain part in the product specification, establishing a corresponding relation between the at least certain part in the product specification and first feature information of the first visual data for displaying certain state or part of a described product, and storing the at least certain part in the product specification, the first feature information and a corresponding relation therebetween in the storing module.

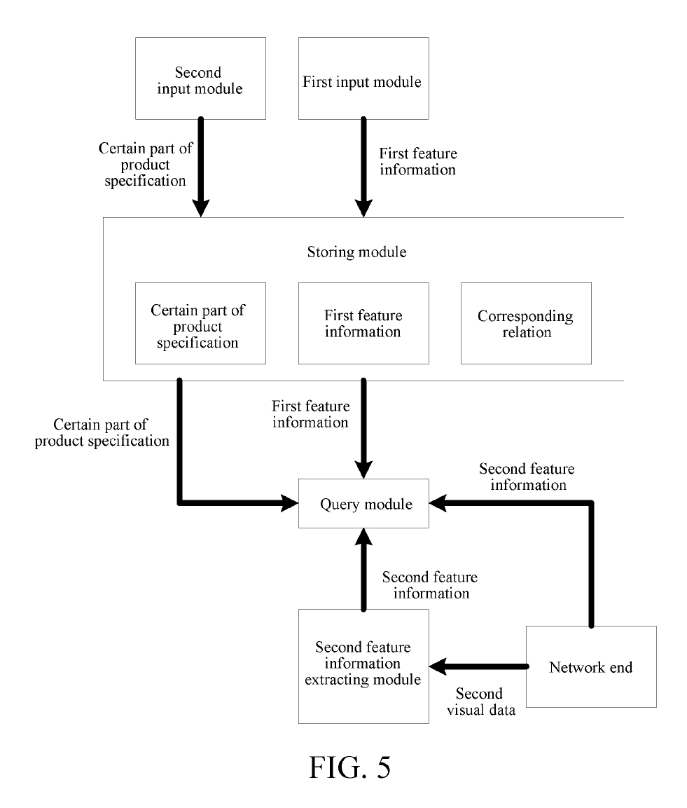

The invention further discloses a query system for a product specification for realizing above query method of the product specification, as shown in FIG. 5, the query system comprises one network device or a plurality of network devices interconnected by a network, and also comprises:

a storing module, for storing the product specification, first feature information of first visual data for displaying certain state or part of a product described in at least certain part in the product specification and a corresponding relation between the first feature information and at least certain part in the product specification on at least one network device;

the visual data are pictures or videos, the visual data and the feature information have a one-to-one corresponding relation, and the network device comprises a network server and a client end.

The query system of the product specification also comprises a query module for comparing the second feature information with the first feature information to determine whether the first visual data and the second visual data display the same state or part of the product, thereby querying a corresponding part in the product specification, and returning a query result; the second feature information is sent from a network, or the second visual data are sent from the network, and the second feature information is extracted from the second visual data by a second feature information extracting module.

In the query system of the product specification, the product specification is at least one of a text, picture, audio format or video format.

In the query system of the product specification, the query result comprises certain part in the product specification or at least one of position indications of certain part in the product specification.

The query system of the product specification also comprises a first input module, inputting and displaying first feature information of first visual data of certain state or part of a product described by at least certain part in the product specification, establishing a corresponding relation between the at least certain part in the product specification and the first feature information, and storing the at least certain part in the product specification, the first feature information and a corresponding relation therebetween in the storing module.

The query system of the product specification also comprises a second input module, inputting at least certain part in the product specification, establishing a corresponding relation between the at least certain part in the product specification and first feature information of the first visual data for displaying certain state or part of a described product, and storing the at least certain part in the product specification, the first feature information and a corresponding relation therebetween in the storing module.

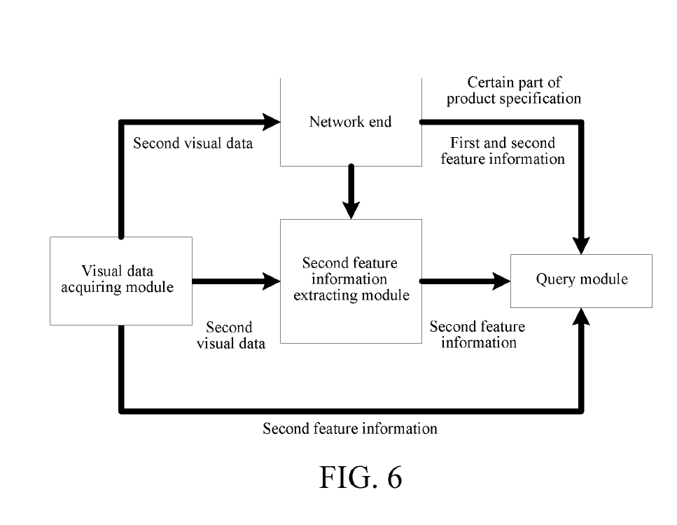

The invention further discloses a query client end for a product specification for realizing above query method of the product specification, as shown in FIG. 6, comprising:

a visual data acquiring module, acquiring second visual data of certain state or part of the product or directly acquiring second feature information of second visual data of certain state or part of the product;

through a network, based on the second visual data or second feature information, certain part of the product specification is queried, and certain part of the product specification describes certain state or part of the product displayed by the second visual data;

the visual data are pictures or videos and the visual data and the feature information have a one-to-one corresponding relation.

The query client end of the product specification also comprises a second feature information extracting module, extracting the second feature information from the second visual data.

The query client end of the product specification also comprises a query module for comparing the second feature information with the first feature information to determine whether the first visual data and the second visual data display the same state or part of the product, thereby querying a corresponding part in the product specification, and returning a query result.

In the query client end of the product specification, the query result comprises certain part in the product specification or at least one of position indications of certain part in the product specification.

In the query client end of the product specification, the product specification is at least one of a text, picture, audio format or video format.

In the query client end of the product specification, the visual data acquiring module comprises a shooting apparatus, for shooting certain state or certain part of a product or second feature information, to acquire the second visual data or directly acquire the second feature information.

The query client end of the product specification also comprises a visual data processing module, selecting a local containing the second visual data from the visual data of large size as the second visual data; or selecting a local containing the second feature information from the visual data of large size as the second feature information.

The query client end of the product specification also comprises a first input module, inputting and displaying first feature information of first visual data of certain state or part of a product described by at least certain part in the product specification, establishing a corresponding relation between the at least certain part in the product specification and the first feature information, and locally storing or uploading the at least certain part in the product specification, the first feature information and a corresponding relation therebetween through a network.

The query client end of the product specification also comprises a second input module, inputting at least certain part in the product specification, establishing a corresponding relation between the at least certain part in the product specification and first feature information of the first visual data for displaying certain state or part of a described product, and locally storing or uploading the at least certain part in the product specification, the first feature information and a corresponding relation therebetween through a network.

By adopting a query method, apparatus system and client end of a product specification, a user can acquire a local picture or video by shooting or other ways, the picture or video is subject to feature information extracting, meanwhile, a prestored picture or video corresponding to certain part of the specification is subject to feature information extracting, or prestored feature information is directly called to compare with the feature information acquired by the user, thus querying a specific part in the product specification.

Through above technical solutions of the invention, the user can query to obtain a corresponding product specification by using a picture or video of certain state or part of a product, thus greatly improving the query efficiency on content of the specification and facilitating the user to acquire information valuable for the user on the product specification.

Above embodiments are only preferable embodiments of the invention instead of limiting the range a substantial technical content of the invention, the substantial technical content of the invention is generally defined in the scope of applied claims, technical entities or methods finished by other people are all covered in the scope of the claims if being identically same as the scope of the applied claims or an equivalent alternation.

1. A query method of a product specification,
comprising:
establishing a corresponding relation between at least certain part in the product specification and first visual data for displaying certain state or part of a described product, and storing the at least certain part in the product specification, the first visual data, and the corresponding relation;
extracting first feature information of the first visual data;
acquiring second visual data for displaying certain state or part of the product, extracting second feature information of the second visual data, or directly acquiring second feature information of the second visual data for displaying certain state or part of the product; and
comparing the second feature information with the first feature information to determine whether the first visual data and the second visual data display the same state or part of the product, thereby querying a corresponding part in the product specification, and returning a query result,
wherein the visual data comprise pictures or videos and the visual data and the feature information have a one-to-one corresponding relation.

2. The query method of the product specification of claim 1, wherein, the product specification is at least one of a text, picture, audio format or video format.

3. The query method of the product specification of claim 1, wherein, ways for directly acquiring the second visual data and second feature information comprise:
shooting certain state or part of the product or the second feature information; and
acquiring a file containing the second visual data or second feature information.

4. The query method of the product specification of claim 3, wherein, a way of directly acquiring the second visual data and the second feature information also comprises, selecting a local containing the second visual data from the visual data of large size as the second visual data; or selecting a local containing the second feature information from the visual data of large size as the second feature information.

5. The query method of the product specification of claim 1, wherein, the product specification, first visual data and a corresponding relation thereof are stored in the same computer system, first feature information is extracted in the computer system, the second visual data and second feature information are acquired in the computer system, or the second feature information is directly acquired, and the second feature and the first feature information are compared in the computer system to query a corresponding part in the product specification and return the query result.

6. The query method of the product specification of claim 1, wherein, the query method of the product specification is realized based on the network, at all same, or partial same or all different network positions, the product specification, the first visual data and a corresponding relation between the at least certain part in the product specification and the first visual data are stored, the first feature information is extracted, the second visual data are acquired or the second feature information is directly acquired, the second feature information is extracted from the second visual data, and the second feature information and the first feature information are compared; different network positions perform communication connection by a network, and are used for transmitting the visual data, the feature information or the query result.

7. The query method of the product specification of claim 1, wherein, the query result comprises certain part in the product specification, or at least one of position indications of certain part in the product specification.

8. The query method of the product specification of claim 1, wherein, a product specification is assigned, and then in the assigned product specification, a corresponding part therein is queried.

9. The query method of the product specification of claim 1, also comprising: establishing new visual data of certain state or part of the product described by at least certain part in the product specification, establishing a corresponding relation between the at least certain part in the product specification and the new visual data, and storing the at least certain part in the product specification, the new visual data and a corresponding relation.

10. The query method of the product specification of claim 1, also comprising: adding additional product specification, establishing a corresponding relation between the additional product specification and the first visual data for displaying certain state or part of the described product, and storing the additional product specification, the first visual data and a corresponding relation.

11. A query apparatus, comprising:
a storing circuitry, storing the product specification, first visual data for displaying certain state or part of a product described by at least certain part in the product specification, and a corresponding relation between the at least certain part in the product specification and the first visual data;
a visual data acquiring circuitry, acquiring second visual data of certain state or part of the product or directly acquiring second feature information of second visual data of certain state or part of the product;
a feature information extracting circuitry, extracting first feature information from the first visual data and second feature information from the second visual data; and
a query circuitry, comparing the second feature information with the first feature information to determine whether the first visual data and the second visual data display the same state or part of the product, thereby querying a corresponding part in the product specification, and returning a query result,
wherein the visual data are pictures or videos and the visual data and the feature information have a one-to-one corresponding relation.

12. The query apparatus of the product specification of claim 11, wherein, the product specification is at least one of a text, picture, audio format or video format.

13. The query apparatus of the product specification of claim 11, wherein, the visual data acquiring circuitry comprises a shooting apparatus, for shooting certain state or certain part of a product or second feature information, to acquire the second visual data or directly acquire the second feature information.

14. The query apparatus of the product specification of claim 13, also comprising a visual data processing circuitry, selecting a local containing the second visual data from the visual data of large size as the second visual data; or selecting a local containing the second feature information from the visual data of large size as the second feature information.

15. The query apparatus of the product specification of claim 11, wherein, the query result comprises certain part in the product specification or at least one of position indications of certain part in the product specification.

16. The query apparatus of the product specification of claim 11, also comprising a first input circuitry, inputting and displaying first visual data of certain state or part of a product described by at least certain part in the product specification, establishing a corresponding relation between the at least certain part in the product specification and the first visual data, and storing the at least certain part in the product specification, the first visual data and a corresponding relation therebetween in the storing circuitry.

17. The query apparatus of the product specification of claim 11, also comprising a second input circuitry, inputting at least certain part in the product specification, establishing a corresponding relation between the at least certain part in the product specification and the first visual data for displaying certain state or part of a described product, and storing the at least certain part in the product specification, the first visual data and a corresponding relation therebetween in the storing circuitry.

18. A query system for providing a product specification, comprising one network device or a plurality of network devices interconnected by a network, and also comprising:
a non-transitory computer-readable storage configured to store the product specification, first visual data for displaying certain state or part of a product described in at least certain part in the product specification and a corresponding relation between the first visual data and at least certain part in the product specification on at least one network device,
wherein the visual data are pictures or videos, the visual data and the feature information have a one-to-one corresponding relation, and the network device comprises a network server and a client end.

19. The query system of the product specification of claim 18, wherein, the network device is configured to extract first feature information from the first visual data.

20. The query system of the product specification of claim 19, further configured to compare the second feature information with the first feature information to determine whether the first visual data and the second visual data display the same state or part of the product, thereby querying a corresponding part in the product specification, and returning a query result; the second feature information is sent from a network, or the second visual data are sent from the network, and the second feature information is extracted from the second visual data.

21-67. (canceled)
